(19) United States
(12) Patent Application Publication
(10) Pub. No.: US 2025/0233183 A1
(43) Pub. Date: Jul. 17, 2025

(54) HYDROCARBON-BASED DYNAMIC COVALENT POLYMER ELECTROLYTE AND A FUEL CELL INCLUDING THE SAME

(71) Applicants: Hyundai Motor Company, Seoul (KR); Kia Corporation, Seoul (KR); Industrial Cooperation Foundation Jeonbuk National University, Jeonju (KR)

(72) Inventors: Seong Jun Jo, Yongin (KR); Sung Kon Kim, Jeonju (KR); Seong Hyeon Yang, Iksan (KR)

(21) Appl. No.: 18/788,895

(22) Filed: Jul. 30, 2024

(30) Foreign Application Priority Data
Jan. 11, 2024 (KR) 10-2024-0004534

(51) Int. Cl. H01M 8/1034; H01M 4/88; H01M 4/90; H01M 8/10; H01M 8/1051

(52) U.S. Cl. CPC H01M 8/1034; H01M 4/881; H01M 4/9008; H01M 4/9041; H01M 8/1051; H01M 2008/1095; H01M 2250/20

(57) ABSTRACT

Described are a hydrocarbon-based dynamic covalent polymer electrolyte and a fuel cell capable of operating under conditions of high temperature and no humidity including the same.

### CROSS-REFERENCE TO RELATED APPLICATION

This application claims, under 35 U.S.C. § 119 (a), the benefit of Korean Patent Application No. 10-2024-0004534, filed on Jan. 11, 2024, the entire contents of which are incorporated herein by reference.

### BACKGROUND

### Technical Field

The present disclosure relates to a hydrocarbon-based polymer electrolyte and a fuel cell capable of operating under conditions of high temperature and no humidity including the same.

### Background

Currently, fuel cells using perfluorinated polymer electrolyte membranes have been commercialized by being mounted on hydrogen electric vehicles, but there is still a problem of high electrolyte membrane manufacturing costs.

When the fuel cell operates at 100° C. or higher, there is no need for a humidifier, and in particular, carbon dioxide poisoning does not occur at 150° C. or higher. However, ionomers used in existing electrolyte membranes are limited in use due to problems with an ion transfer mechanism and durability at high temperatures.

Currently, the most widely used polymer electrolyte membrane for fuel cells is a perfluorinated ion exchange membrane, and Nafion is the most popular thereamong. A Nafion membrane has high production costs because synthetic materials and manufacturing process are very complicated. Water management is very important during operation of existing commercial membranes, but the number of water molecules decreases due to dehydration upon operation at 100° C. or higher, and as a result, dissociation of ion pairs becomes difficult and proton conductivity decreases. Hydrocarbon-based polymer electrolyte membranes mainly use materials with aromatic rings for durability, but the spacing between chains is narrow due to bulky aromatic rings, making it difficult to form large ion transfer channels.

Accordingly, a hydrocarbon-based polymer electrolyte in the form of polybenzimidazole (PBI) containing phosphoric acid, which has durability at high temperatures and a new ion transfer mechanism, is receiving attention. However, when polybenzimidazole containing phosphoric acid has high phosphoric acid content, the mechanical properties of the electrolyte membrane are deteriorated. Moreover, polybenzimidazole containing phosphoric acid is problematic in that phosphoric acid is dissolved during operation, lowering proton conductivity over time.

### SUMMARY

An object of the present disclosure is to provide a hydrocarbon-based polymer electrolyte with a new proton transfer mechanism.

Another object of the present disclosure is to provide a hydrocarbon-based polymer electrolyte with excellent durability at high temperatures.

Still another object of the present disclosure is to provide a hydrocarbon-based polymer electrolyte with excellent mechanical properties.

Yet another object of the present disclosure is to provide a hydrocarbon-based polymer electrolyte that may be reshaped by hot pressing or the like due to covalent bonding.

The objects of the present disclosure are not limited to the foregoing. The objects of the present disclosure will be able to be clearly understood through the following description and to be realized by the means described in the claims and combinations thereof.

An exemplary embodiment of the present disclosure may provide a hydrocarbon-based polymer electrolyte, including a copolymer in which epoxy compounds having at least one epoxide functional group at an end thereof are linked through a crosslinking agent.

The epoxy compounds may include at least one selected from compounds represented by Structural Formula 1-1 to Structural Formula 1-9 below.

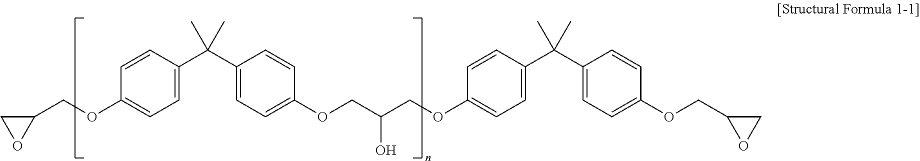

In the Structural Formula 1-1, n may be an integer from 1 to 1,000.

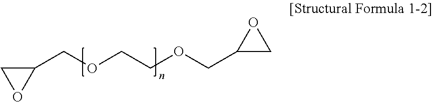

In the Structural Formula 1-2, n may be an integer from 1 to 1,000.

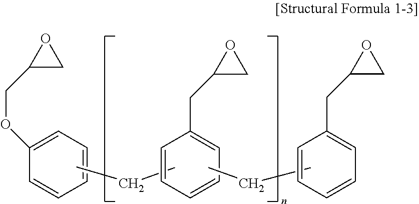

In the Structural Formula 1-3, n may be an integer from 1 to 1,000.

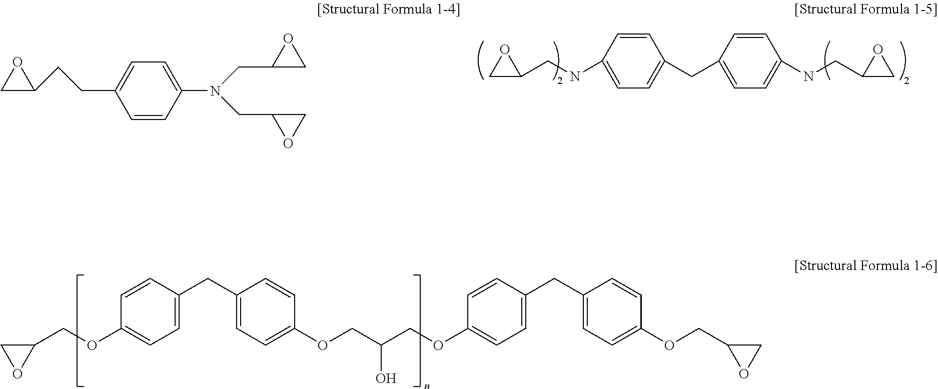

In the Structural Formula 1-6, n may be an integer from 1 to 1,000.

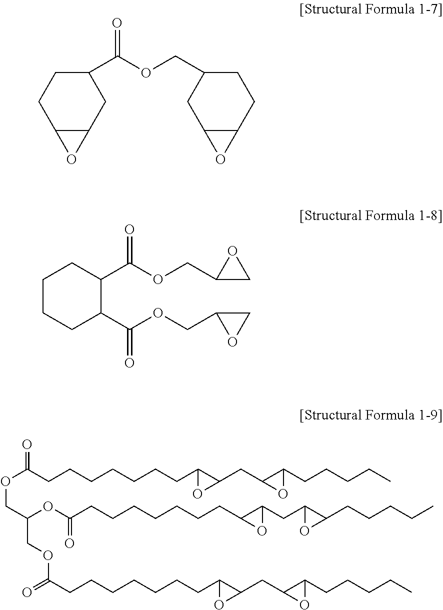 [SMILES: O=C(OCC1CCC2OC2C1)C1CCC2OC2C1 ; O=C(OCC1CO1)C1CCCCC1C(=O)OCC1CO1 ; CCCCCC1OC1CC1OC1CCCCCCCC(=O)OCC(COC(=O)CCCCCCCC1OC1CC1OC1CCCCC)OC(=O)CCCCCCCC1OC1CC1OC1CCCCC]

The epoxy compounds may include at least two compounds represented by the Structural Formula 1-1 to the Structural Formula 1-9.

The epoxy compounds may include a compound represented by the Structural Formula 1-1 and a compound represented by the Structural Formula 1-2 below.

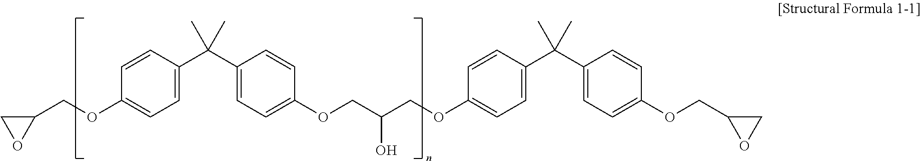

In the Structural Formula 1-1, n may be an integer from 1 to 1,000.

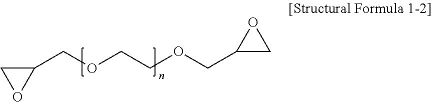

In the Structural Formula 1-2, n may be an integer from 1 to 1,000.

The epoxy compound may include the compound represented by the Structural Formula 1-1 and the compound represented by the Structural Formula 1-2 at a molar ratio of about 4:6 to 8:2.

The epoxy compounds may include the compound represented by the Structural Formula 1-1 and the compound represented by the Structural Formula 1-2 at a molar ratio of about 8:2.

The dynamic covalent crosslinking agent may include at least one selected from among phosphoric acid and derivatives thereof. Other suitable dynamic covalent crosslinking agents may include e.g. amine-based crosslinking agents such as DETDA (Diethyltoluene diamine), TETA (etriethylenetetramine) or MDA (Methylene diamine).

The equivalent ratio of the epoxy compounds to the dynamic covalent crosslinking agent may be about 1:1 to 1:4. An equivalent ratio of the epoxy compounds to the dynamic covalent crosslinking agent may be about 1:3.

The hydrocarbon-based polymer electrolyte may include at least one selected from partial structures represented by Structural Formula 2-1 to Structural Formula 2-3 below in a crosslinked state.

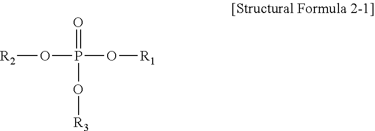

In the Structural Formula 2-1, each of R₁, R₂, and R₃ may include hydrogen or

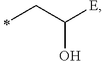

at least one selected from R₁, R₂, and R₃ may include

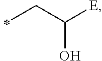

and E may be the epoxy compounds.

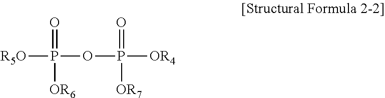

In the Structural Formula 2-2, each of R₄, R₅, R₆, and R₇ may include hydrogen or

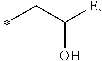

at least one selected from R₄, R₅, R₆, and R₇ may include

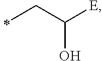

and E may be the epoxy compounds.

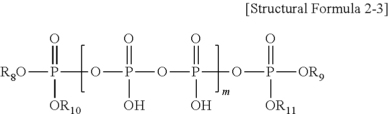

In the Structural Formula 2-3, each of R₈, R₉, R₁₀, and R₁₁ may include hydrogen or

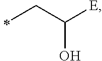

at least one selected from R₈, R₉, R₁₀, and R₁₁ may include

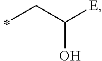

E may be the epoxy compounds, and m may be an integer from 1 to 4.

Another exemplary embodiment is directed to a hydrocarbon-based polymer electrolyte, comprising a copolymer in which epoxy compounds comprising at least one epoxide functional group at an end thereof are linked through a dynamic covalent crosslinking agent,

wherein the epoxy compounds comprise a compound represented by the Structural Formula 1-1 and a compound represented by the Structural Formula 1-2:

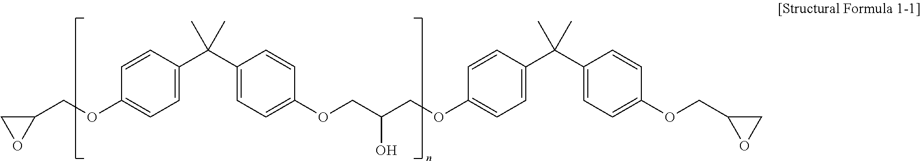

in the Structural Formula 1-1, n is an integer from 1 to 1,000;

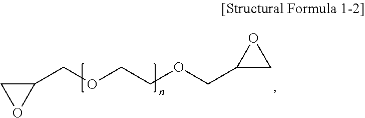

and wherein the hydrocarbon-based polymer electrolyte comprises a partial structure represented by the Structural Formula 2-1 below in a crosslinked state:

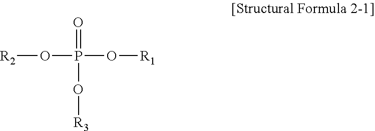

in the Structural Formula 2-1, each of R₁, R₂, and R₃ comprises hydrogen.

Another embodiment of the present disclosure provides a fuel cell, including an electrolyte membrane, an anode disposed on one surface of the electrolyte membrane, and a cathode disposed on the remaining surface of the electrolyte membrane, in which at least one selected from among the electrolyte membrane, the anode, and the cathode may include the hydrocarbon-based polymer electrolyte described above.

The anode or the cathode may include a catalyst or an ionomer. The catalyst may include a precious metal catalyst, a non-precious metal catalyst, or an alloy catalyst thereof. The ionomer may include a phosphoric acid-doped polybenzimidazole-based polymer.

Another exemplary embodiment is directed to a vehicle comprising the fuel cell.

As discussed, the method and system suitably include use of a controller or processer.

### BRIEF DESCRIPTION OF THE DRAWINGS

The above and other features of the present disclosure will now be described in detail referring to certain exemplary embodiments thereof illustrated in the accompanying drawings, which are given hereinbelow by way of illustration only, and thus are not limitative of the present disclosure, and wherein:

FIG. 1 shows a fuel cell according to the present disclosure;

FIG. 2 shows a stress relaxation test for an electrolyte membrane according to Example 1;

FIG. 3 shows viscosity of the electrolyte membrane according to Example 1 depending on temperature;

FIG. 4 shows mechanical strength of the electrolyte membranes according to Examples 1 to 4;

FIG. 5A shows specimens prepared by cutting the electrolyte membrane according to Example 3;

FIG. 5B shows results of reshaping by hot pressing of the specimens of FIG. 5A;

FIG. 6A shows specimens prepared by cutting an electrolyte membrane according to Comparative Example; and

FIG. 6B shows results of reshaping by hot pressing of the specimens of FIG. 6A.

### DETAILED DESCRIPTION

The above and other objects, features and advantages of the present disclosure will be more clearly understood from the following preferred embodiments taken in conjunction with the accompanying drawings. However, the present disclosure is not limited to the embodiments disclosed herein, and may be modified into different forms. These embodiments are provided to thoroughly explain the disclosure and to sufficiently transfer the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween. It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. In addition, the terms “unit”, “-er”, “-or”, and “module” described in the specification mean units for processing at least one function and operation, and can be implemented by hardware components or software components and combinations thereof.

The term “ionomer” as used herein refers to a polymeric material or resin that includes ionized groups attached (e.g. covalently bonded) to the backbone of the polymer as pendant groups. Preferably, such ionized groups may be functionalized to have ionic characteristics, e.g., cationic or anionic.

The ionomer may suitably include one or more polymers selected from the group consisting of a fluoro-based polymer, a perfluorosulfone-based polymer, a benzimidazole-based polymer, a polyimide-based polymer, a polyetherimide-based polymer, a polyphenylene sulfide-based polymer, a polysulfone-based polymer, a polyethersulfone-based polymer, a polyetherketone-based polymer, a polyether-etherketone-based polymer, a polyphenylquinoxaline-based polymer and a polystyrene-based polymer.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

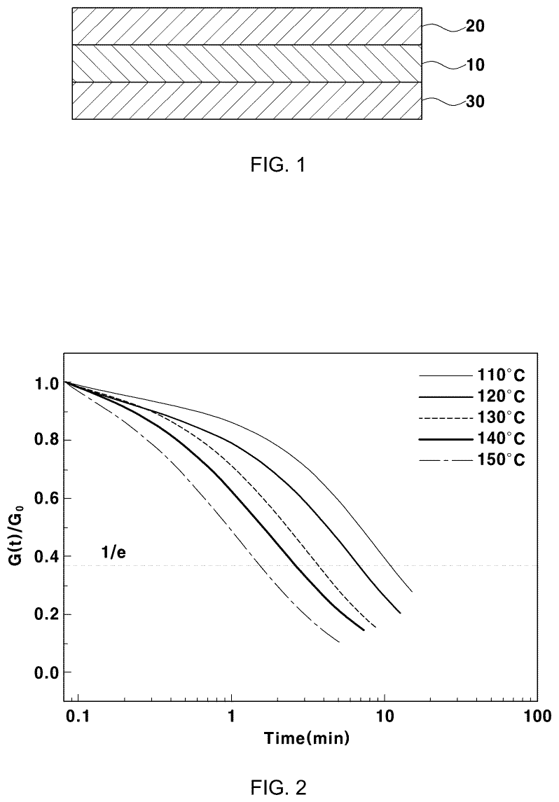

FIG. 1 shows a fuel cell according to the present disclosure.

The fuel cell may be a high-temperature polymer electrolyte membrane (PEM) fuel cell that operates at a high temperature of about 120° C. to 180° C. Also, the fuel cell may be a high-temperature polymer electrolyte membrane fuel cell that operates at a relative humidity of about 50% or less. While it shares the same structure and principles as existing low-temperature PEM fuel cells, it offers distinct advantages, including the prevention of water flooding at the anode and eliminating the need for a humidification system.

The fuel cell may include an electrolyte membrane 10, an anode 20 disposed on one surface of the electrolyte membrane 10, and a cathode 30 disposed on the remaining surface of the electrolyte membrane 10.

The electrolyte membrane 10, the anode 20, and the cathode 30 are not limited in shape, thickness, area, etc., and any type commonly used in the technical field to which the present disclosure belongs may be applied.

At least one selected from among the electrolyte membrane 10, the anode 20, and the cathode 30 may include a hydrocarbon-based polymer electrolyte.

The hydrocarbon-based polymer electrolyte may have proton conductivity. The proton conductivity may indicate the ability to conduct or exchange protons (H⁺) to move in the fuel cell.

The hydrocarbon-based polymer electrolyte may include a copolymer in which epoxy compounds having at least one epoxide functional group at an end thereof are linked to a crosslinking agent by dynamic covalent bonding.

In this context, “dynamic covalent bonding” may refer to temperature-dependent dynamic covalent bonding. In this regard, dynamic covalent bonding can indicate, a covalent bond in which binding reaction and dissociation reaction occur reversibly depending on temperature, such as heating and cooling. Because molecular chains bind by covalent bonding in a temperature-dependent manner, the fluidization temperature is high compared to copolymers where molecular chains do not bind to each other. The fluidization temperature of the hydrocarbon-based polymer electrolyte is not particularly limited, varying with its structure, molecular weight, and other characteristics. In one aspect, a dynamic covalent bond may be assessed by a stress relaxation test as shown in the examples which follows (including Example 1) where viscosity decreases with increased temperature such as a temperature in excess of 60° C., 70° C., 80° C., 90° C., 100° C., 110° C., 120° C., 130° C., 140° C. or 150° C. or more, including over a range within those temperature, such as from 70° C. to 150° C. or 110° C. to 150° C. In this regard, in at least certain aspects, a “dynamic covalent crosslinking agent” refers to a crosslinking agent that upon reaction provides a crosslinked polymer network that can dissociate (as shown by viscosity differences and/or stress relaxation test) at elevated temperatures such as in excess of 60° C., 70° C., 80° C., 90° C., 100° C., 110° C., 120° C., 130° C., 140° C. or 150° C. or more. In the hydrocarbon-based polymer electrolyte, phosphoric acid, which is a dynamic covalent crosslinking agent, is coupled with an epoxy compound. This configuration eliminates the issue of phosphoric acid release that is observed in conventional phosphoric acid-doped or impregnated polybenzimidazole.

When phosphoric acid, which is a dynamic covalent crosslinking agent, reacts with the epoxide functional group of an epoxy compound, phosphate ester, hydroxyl group, and pyrophosphate are formed, creating a multi-network structure. Accordingly, incorporating the hydrocarbon-based polymer electrolyte may enhance mechanical properties of the electrolyte membrane 10, the anode 20, and/or the cathode 30.

The hydrocarbon-based polymer electrolyte conducts or exchanges protons through the phosphate ester and the hydroxyl group and thus has a new proton conduction mechanism.

The epoxy compounds may include at least one selected from compounds represented by Structural Formula 1-1 to Structural Formula 1-9 below.

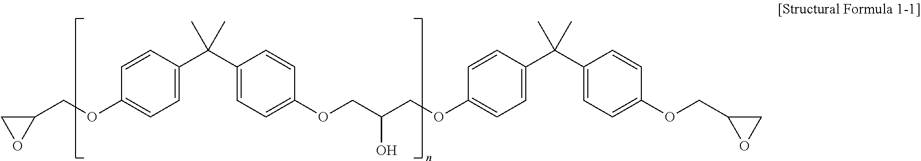

In Structural Formula 1-1, n may be an integer from 1 to 1,000.

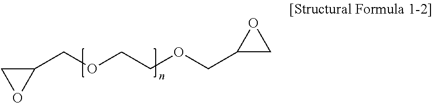

In Structural Formula 1-2, n may be an integer from 1 to 1,000.

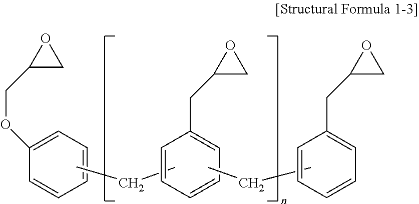

In Structural Formula 1-3, n may be an integer from 1 to 1,000.

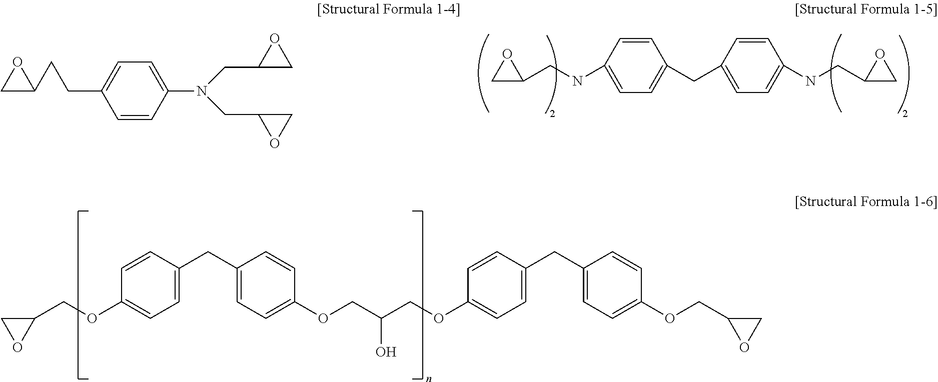

In Structural Formula 1-6, n may be an integer from 1 to 1,000.

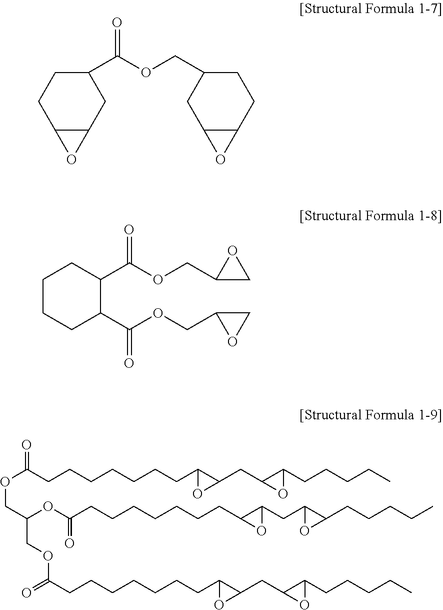 [SMILES: O=C(OCC1CCC2OC2C1)C1CCC2OC2C1 ; O=C(OCC1CO1)C1CCCCC1C(=O)OCC1CO1 ; CCCCCC1OC1CC1OC1CCCCCCCC(=O)OCC(COC(=O)CCCCCCCC1OC1CC1OC1CCCCC)OC(=O)CCCCCCCC1OC1CC1OC1CCCCC]

Specifically, the epoxy compounds may include a compound represented by Structural Formula 1-1 and a compound represented by Structural Formula 1-2 at a molar ratio of 4:6 to 8:2. Achieving the specific molar ratio range may ensure that both mechanical properties and proton conductivity are improved in a balanced manner.

The crosslinking agent may include at least one selected from among phosphoric acid, amine-based crosslinking agent and derivatives thereof. The derivative of phosphoric acid is not particularly limited, but may include, for example, pyrophosphate having a P—O—P bond. The amine-based crosslinking agent may include DETDA (Diethyltoluene diamine), TETA (etriethylenetetramine) or MDA (Methylene diamine).

The equivalent ratio of the epoxy compounds to the crosslinking agent may be 1:1 to 1:4. When the numerical range of the equivalent ratio is satisfied, mechanical properties and proton conductivity may be improved in a balanced manner.

The hydrocarbon-based polymer electrolyte may include at least one selected from partial structures represented by Structural Formula 2-1 to Structural Formula 2-3 below in a crosslinked state.

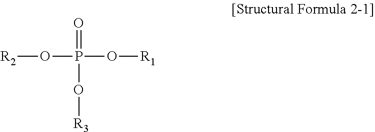

In Structural Formula 2-1, each of R₁, R₂, and R₃ may be hydrogen or

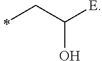

Specifically, at least one selected from R₁, R₂, and R₃ may be

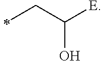

Here, E may include any one selected from among the epoxy compounds described above.

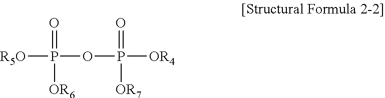

In Structural Formula 2-2, each of R₄, R₅, R₆, and R₇ may be hydrogen or

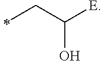

Specifically, at least one selected from R₄, R₅, R₆, and R₇ may be

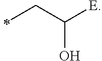

Here, E may include any one selected from among the epoxy compounds described above.

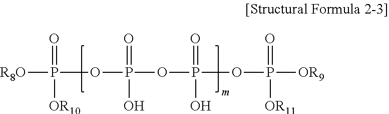

In Structural Formula 2-3, each of R₈, R₉, R₁₀, and R₁₁ may be hydrogen or

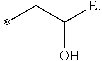

Specifically, at least one selected from R₈, R₉, R₁₀, and R₁₁ may be

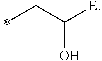

Here, E may include any one selected from the epoxy compounds described above.

Also, m may be an integer from 1 to 4.

An example of the hydrocarbon-based polymer electrolyte may include a copolymer represented by Structural Formula 3 below. However, the hydrocarbon-based polymer electrolyte according to the present disclosure is not limited to the following copolymer.

[Structural Formula 3]

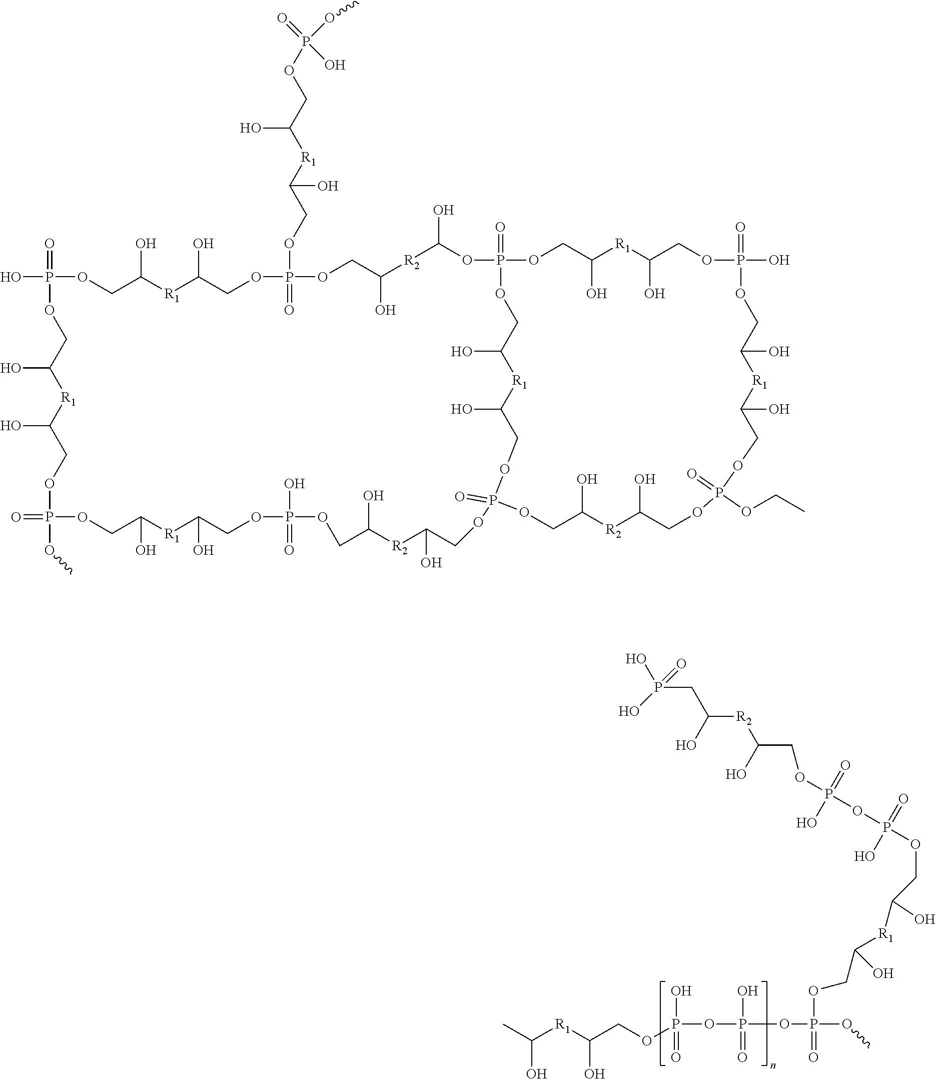

In Structural Formula 3, R₁ may include

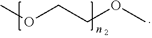

R₂ may include

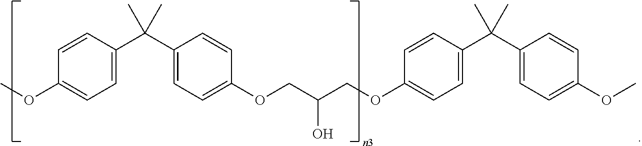

Also, n₁ may be an integer from 1 to 4, n₂ may be an integer from 1 to 1,000, and n₃ may be an integer from 1 to 1,000.

The electrolyte membrane 10 may further include an ionomer having proton conductivity, in addition to the hydrocarbon-based polymer electrolyte. The ionomer may include any material commonly used in the technical field to which the present disclosure belongs. For example, the ionomer may include phosphoric acid-doped polybenzimidazole-based polymer.

Each of the anode 20 and the cathode 30 may include a catalyst and an ionomer.

The catalyst may include any material commonly used in the technical field to which the present disclosure belongs. For example, the catalyst may include a precious metal catalyst such as platinum (Pt), a non-precious metal catalyst, or an alloy catalyst thereof.

The ionomer may include any material commonly used in the technical field to which the present disclosure belongs. For example, the ionomer may include a phosphoric acid-doped polybenzimidazole-based polymer.

A better understanding of the present disclosure may be obtained through the following examples. These examples are merely set forth to illustrate the present disclosure, and are not to be construed as limiting the scope of the present disclosure.

### Example 1

An epoxy compound including poly (ethylene glycol diglycidyl) ether (PEGDE) and bisphenol A diglycidyl ether at a molar ratio of 8:2 was prepared. The epoxy compound was added to acetone as an organic solvent and stirred with a stirrer at room temperature for 1 hour.

The stirred solution was placed in an ice bath, after which phosphoric acid as a crosslinking agent was slowly added thereto and stirred for 4 hours. The equivalent ratio of the epoxy compound to the crosslinking agent was adjusted to 1:1.

The result thereof was cured in a convection oven under conditions of 130° C. and 140° C. for 4 hours, 150° C. for 12 hours, and 160° C. for 24 hours. The cured sample was shaped using a hot press at 180° C. and 10 MPa and then post-cured in a convection oven at 180° C., yielding an electrolyte membrane in the form of a film.

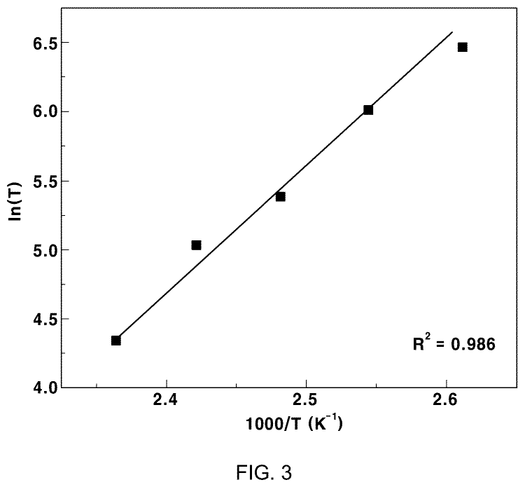

Dynamic mechanical analysis experiment was performed on the electrolyte membrane according to Example 1 in order to confirm whether the hydrocarbon-based polymer electrolyte according to the present disclosure has a dynamic covalent bond. FIG. 2 is a graph showing results of a stress relaxation test for the electrolyte membrane according to Example 1. FIG. 3 is a graph showing the viscosity of the electrolyte membrane according to Example 1 depending on temperature, in which Arrhenius analysis was performed.

Referring thereto, the hydrocarbon-based polymer electrolyte constituting the electrolyte membrane according to Example 1 had a network structure through dynamic covalent bonding, and also phosphate ester and a β-hydroxyl group resulting from opening of an epoxy ring were formed upon preparation of the polymer, making it possible to exchange and conduct protons under specific conditions. The stress relaxation test was performed from 110° C. to 150° C., and the viscosity did not decrease drastically but decreased steadily with temperature, confirming that the hydrocarbon-based polymer electrolyte of Example 1 had a dynamic covalent bond.

### Example 2

An electrolyte membrane was manufactured in the same manner as in Example 1, with the exception that the equivalent ratio of the epoxy compound to the crosslinking agent was adjusted to 1:2.

### Example 3

An electrolyte membrane was manufactured in the same manner as in Example 1, with the exception that the equivalent ratio of the epoxy compound to the crosslinking agent was adjusted to 1:3.

### Example 4

An electrolyte membrane was manufactured in the same manner as in Example 1, with the exception that the equivalent ratio of the epoxy compound to the crosslinking agent was adjusted to 1:4.

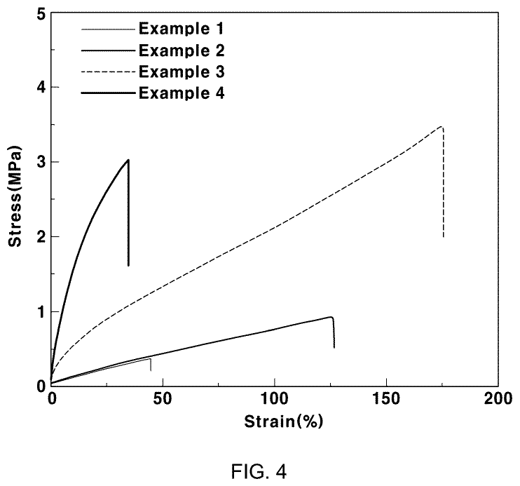

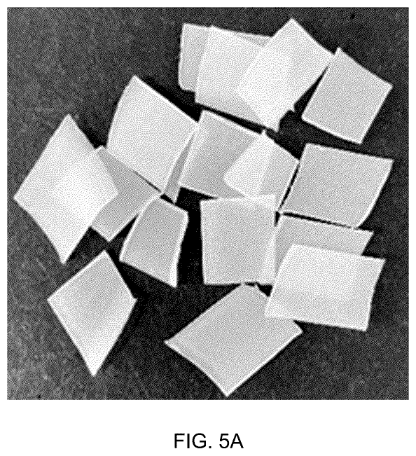

FIG. 4 shows mechanical strength of the electrolyte membranes according to Examples 1 to 4. A universal testing machine was used. The size of the specimen followed the ASTM D638 Type V standard, and the test was performed under conditions of a crosshead speed of 10 mm/min, room temperature (23±2° C.), and relative humidity of 50±5%.

The tensile strength and elongation of each electrolyte membrane are shown in Table 1 below.

TABLE 1

| Items | Tensile strength [MPa] | Elongation [%] |
|---|---|---|
| Example 1 | 0.405 | 44.06 |
| Example 2 | 0.907 | 127.14 |
| Example 3 | 3.471 | 176.31 |
| Example 4 | 3.017 | 35.07 |

As the equivalent ratio of the phosphoric acid relative to the epoxy compound increased, mechanical strength and elongation increased. This is deemed to be because a P—O—P bond is formed by pyrophosphate reaction in which phosphoric acids react with each other at a high temperature, creating a multi-network structure.

The proton conductivity of the electrolyte membranes according to Examples 1 to 4 was measured. The proton conductivity of each electrolyte membrane was measured under a nitrogen atmosphere at 120° C. and 150° C. The results thereof are shown in Table 2 below.

TABLE 2

| | Proton conductivity @120° C. | Proton conductivity @150° C. |
|---|---|---|
| Items | [S/cm] | [S/cm] |
| Example 1 | 1.95 × 10⁻⁶ | 5.54 × 10⁻⁶ |
| Example 2 | 1.41 × 10⁻⁴ | 3.25 × 10⁻⁴ |
| Example 3 | 6.25 × 10⁻⁴ | 2.04 × 10⁻³ |
| Example 4 | 5.38 × 10⁻³ | 1.79 × 10⁻³ |

Referring to Table 2, proton conductivity tended to increase with an increase in the equivalent ratio of phosphoric acid. However, when the equivalent ratio was 1:4, pyrophosphate was formed and proton conductivity slightly decreased.

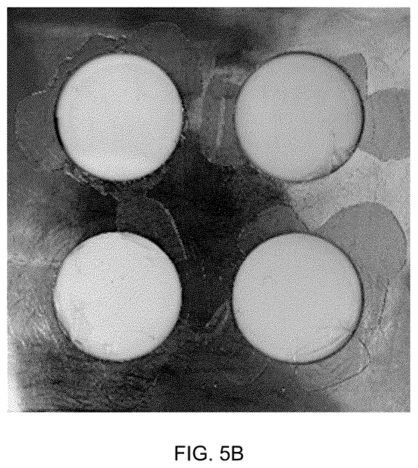

Specimens as shown in FIG. 5A were prepared by cutting the electrolyte membrane according to Example 3. Whether the specimens could be reshaped by hot pressing under conditions of about 180° C. and 10 MPa was tested. The results thereof are shown in FIG. 5B. Referring thereto, the electrolyte membrane according to the present disclosure was reshaped by hot pressing by virtue of dynamic covalent bonding.

As Comparative Example, an electrolyte membrane including poly (phosphoric acid 2-hydroxyethyl methacrylate ester) represented by the following structural formula was prepared.

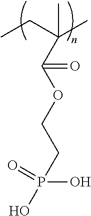

(n is an integer from 20 to 100)

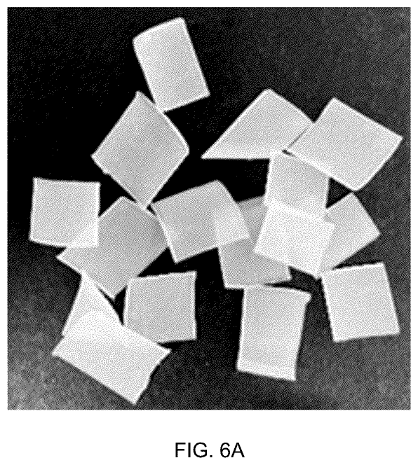

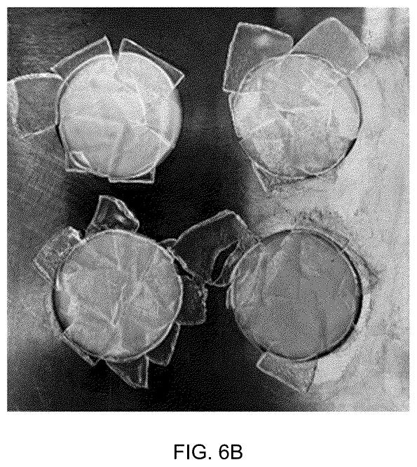

Specimens as shown in FIG. 6A were prepared by cutting the electrolyte membrane of Comparative Example. Whether the specimens could be reshaped by hot pressing under conditions of about 180° C. and 10 MPa was tested. The results thereof are shown in FIG. 6B. Referring thereto, the electrolyte membrane according to Comparative Example was not reshaped by hot pressing due to no dynamic covalent bonding.

According to the present disclosure, a hydrocarbon-based polymer electrolyte with a new proton transfer mechanism can be obtained.

According to the present disclosure, a hydrocarbon-based polymer electrolyte with excellent durability at high temperatures can be obtained.

According to the present disclosure, a hydrocarbon-based polymer electrolyte with excellent mechanical properties can be obtained.

According to the present disclosure, a hydrocarbon-based polymer electrolyte that can be reshaped by hot pressing or the like due to dynamic covalent bonding can be obtained.

The effects of the present disclosure are not limited to the above-mentioned effects. It should be understood that the effects of the present disclosure include all effects that can be inferred from the description of the present disclosure.

As the test examples and examples of the present disclosure have been described in detail above, the scope of the present disclosure is not limited to the aforementioned test examples and examples, and various modifications and improvements made by those skilled in the art using the basic concept of the present disclosure defined in the following claims are also within the scope of the present disclosure.

What is claimed is:

1. A hydrocarbon-based polymer electrolyte, comprising a copolymer in which epoxy compounds comprising at least one epoxide functional group at an end thereof are linked through a dynamic covalent crosslinking agent.

2. The hydrocarbon-based polymer electrolyte of claim 1, wherein the epoxy compounds comprise a compound represented by Structural Formula 1-1 to Structural Formula 1-9 below or a combination thereof: 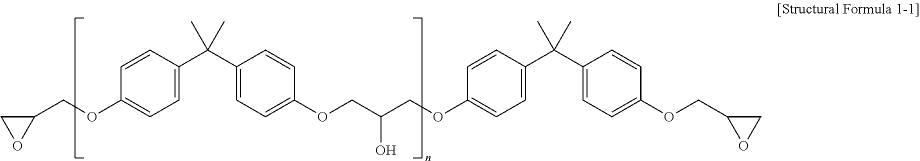
in Structural Formula 1-1, n is an integer from 1 to 1,000; 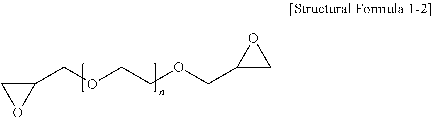
in Structural Formula 1-2, n is an integer from 1 to 1,000; 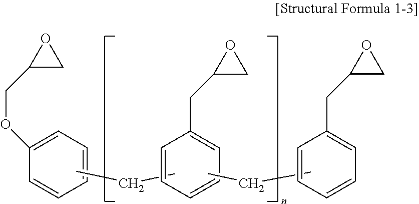
in Structural Formula 1-3, n is an integer from 1 to 1,000; 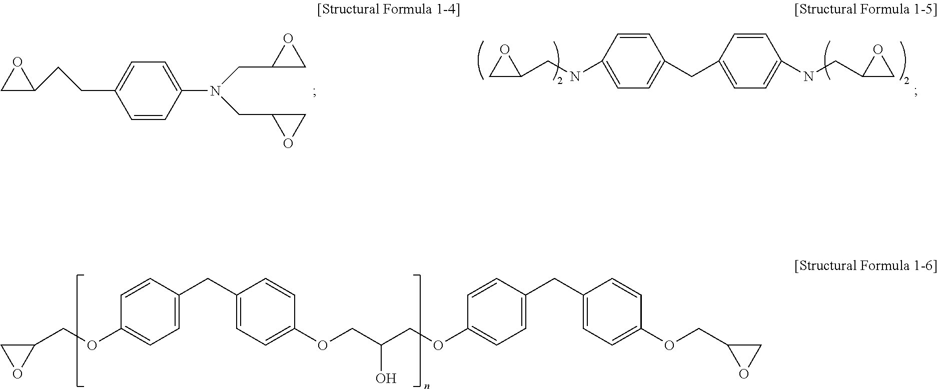
in Structural Formula 1-6, n is an integer from 1 to 1,000;

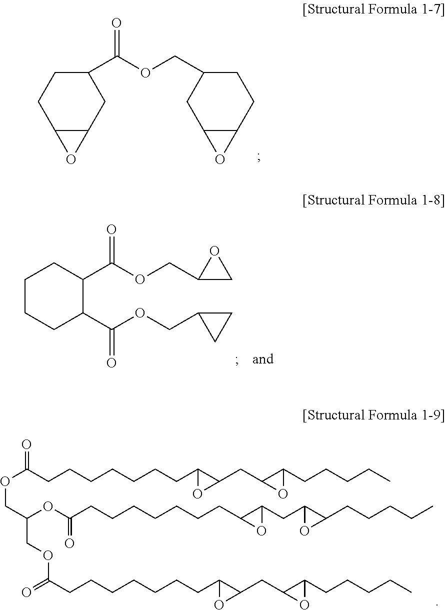 [SMILES: O=C(OCC1CCC2OC2C1)C1CCC2OC2C1 ; O=C(OCC1CC1)C1CCCCC1C(=O)OCC1CO1 ; CCCCCC1OC1CC1OC1CCCCCCCC(=O)OCC(COC(=O)CCCCCCCC1OC1CC1OC1CCCCC)OC(=O)CCCCCCCC1OC1CC1OC1CCCCC]

3. The hydrocarbon-based polymer electrolyte of claim 2, wherein the epoxy compounds comprise at least two compounds represented by the Structural Formula 1-1 to the Structural Formula 1-9.

4. The hydrocarbon-based polymer electrolyte of claim 3, wherein the epoxy compounds comprise a compound represented by the Structural Formula 1-1 and a compound represented by the Structural Formula 1-2.

5. The hydrocarbon-based polymer electrolyte of claim 4, wherein the epoxy compounds comprise the compound represented by the Structural Formula 1-1 and the compound represented by the Structural Formula 1-2 at a molar ratio of about 4:6 to 8:2.

6. The hydrocarbon-based polymer electrolyte of claim 5, wherein the epoxy compounds comprise the compound represented by the Structural Formula 1-1 and the compound represented by the Structural Formula 1-2 at a molar ratio of about 8:2.

7. The hydrocarbon-based polymer electrolyte of claim 1, wherein the dynamic covalent crosslinking agent comprises at least one selected from phosphoric acid, amine-based crosslinking agent, and derivatives thereof.

8. The hydrocarbon-based polymer electrolyte of claim 1, wherein an equivalent ratio of the epoxy compounds to the dynamic covalent crosslinking agent is about 1:1 to 1:4.

9. The hydrocarbon-based polymer electrolyte of claim 8, wherein an equivalent ratio of the epoxy compounds to the dynamic covalent crosslinking agent is about 1:3.

10. The hydrocarbon-based polymer electrolyte of claim 1, wherein the hydrocarbon-based polymer electrolyte comprises a partial structure represented by Structural Formula 2-1 to Structural Formula 2-3 below in a crosslinked state: 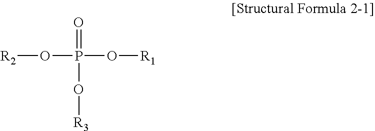
In the Structural Formula 2-1, each of R₁, R₂, and R₃ comprises hydrogen or 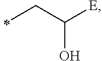
at least one selected from R₁, R₂, and R₃ comprises 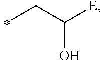
and
E is the epoxy compounds; 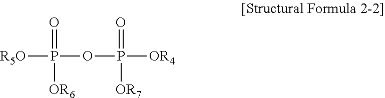
in the Structural Formula 2-2, each of R₄, R₅, R₆, and R₇ comprises hydrogen or 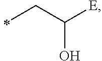
at least one selected from R₄, R₅, R₆, and R₇ comprises 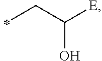
and
E is the epoxy compounds; and 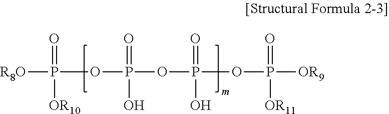
in the Structural Formula 2-3, each of R₈, R₉, R₁₀, and R₁₁ comprises hydrogen or 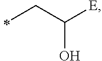
at least one of the R₈, R₉, R₁₀, and R₁₁ comprises 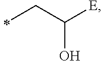
E is the epoxy compounds, and
m is an integer from 1 to 4.

11. The hydrocarbon-based polymer electrolyte of claim 2, wherein the hydrocarbon-based polymer electrolyte comprises a partial structure represented by Structural Formula 2-1 to Structural Formula 2-3 below in a crosslinked state: 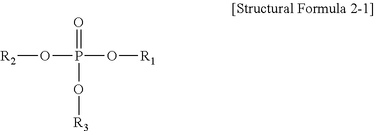
In the Structural Formula 2-1, each of R₁, R₂, and R₃ comprises hydrogen or 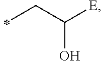
at least one selected from R₁, R₂, and R₃ comprises 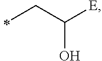
and
E is the epoxy compounds; 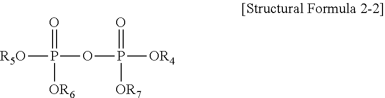
in the Structural Formula 2-2, each of R₄, R₅, R₆, and R₇ comprises hydrogen or 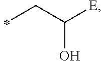
at least one selected from R₄, R₅, R₆, and R₇ comprises 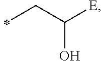
and
E is the epoxy compounds; and 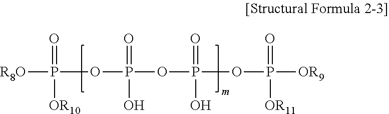
in the Structural Formula 2-3, each of R₈, R₉, R₁₀, and R₁₁ comprises hydrogen or 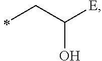
at least one of the R₈, R₉, R₁₀, and R₁₁ comprises 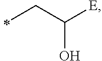
E is the epoxy compounds, and
m is an integer from 1 to 4.

12. The hydrocarbon-based polymer electrolyte of claim 3, wherein the hydrocarbon-based polymer electrolyte comprises a partial structure represented by Structural Formula 2-1 to Structural Formula 2-3 below in a crosslinked state: 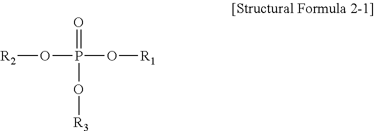
In the Structural Formula 2-1, each of R₁, R₂, and R₃ comprises hydrogen or 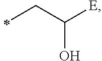
at least one selected from R₁, R₂, and R₃ comprises 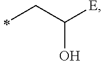
and
E is the epoxy compounds; 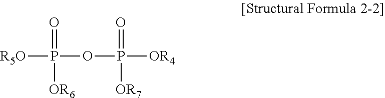
in the Structural Formula 2-2, each of R₄, R₅, R₆, and R₇ comprises hydrogen or 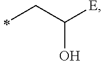
at least one selected from R₄, R₅, R₆, and R₇ comprises 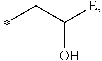
and
E is the epoxy compounds 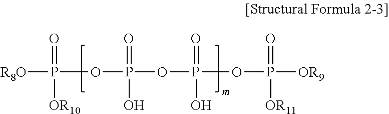
in the Structural Formula 2-3, each of R₈, R₉, R₁₀, and Ru comprises hydrogen or 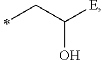
at least one of the R₈, R₉, R₁₀, and R₁₁ comprises 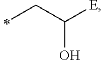
E is the epoxy compounds, and
m is an integer from 1 to 4.

13. The hydrocarbon-based polymer electrolyte of claim 4, wherein the hydrocarbon-based polymer electrolyte comprises a partial structure represented by Structural Formula 2-1 to Structural Formula 2-3 below in a crosslinked state: 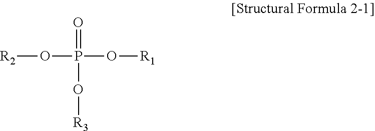
In the Structural Formula 2-1, each of R₁, R₂, and R₃ comprises hydrogen or 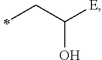
at least one selected from R₁, R₂, and R₃ comprises 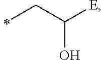
and
E is the epoxy compounds; 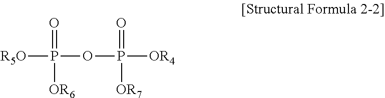
in the Structural Formula 2-2, each of R₄, R₅, R₆, and R₇ comprises hydrogen or 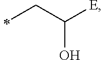
at least one selected from R₄, R₅, R₆, and R₇ comprises 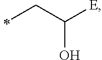
and
E is the epoxy compounds; and 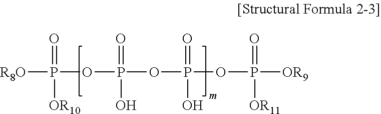
in the Structural Formula 2-3, each of R₈, R₉, R₁₀, and R₁₁ comprises hydrogen or 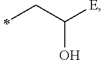
at least one of the R₈, R₉, R₁₀, and R₁₁ comprises 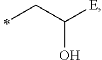
E is the epoxy compounds, and
m is an integer from 1 to 4.

14. The hydrocarbon-based polymer electrolyte of claim 13, wherein the hydrocarbon-based polymer electrolyte comprises a partial structure represented by the Structural Formula 2-1 below in a crosslinked state: 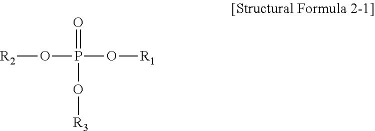
in the Structural Formula 2-1, each of R₁, R₂, and R₃ comprises hydrogen.

15. A hydrocarbon-based polymer electrolyte, comprising a copolymer in which epoxy compounds comprising at least one epoxide functional group at an end thereof are linked through a dynamic covalent crosslinking agent,
wherein the epoxy compounds comprise a compound represented by the Structural Formula 1-1 and a compound represented by the Structural Formula 1-2: 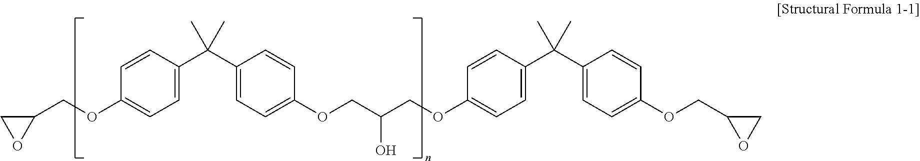
in the Structural Formula 1-1, n is an integer from 1 to 1,000; 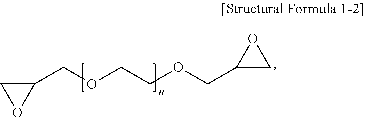
and wherein the hydrocarbon-based polymer electrolyte comprises a partial structure represented by the Structural Formula 2-1 below in a crosslinked state: 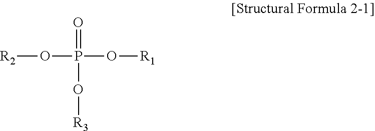
in the Structural Formula 2-1, each of R₁, R₂, and R₃ comprises hydrogen.

16. A fuel cell, comprising:
an electrolyte membrane;
an anode disposed on one surface of the electrolyte membrane; and
a cathode disposed on a remaining surface of the electrolyte membrane,
wherein at least one of the electrolyte membrane, the anode, and the cathode comprises the hydrocarbon-based polymer electrolyte of claim 1.

17. The fuel cell of claim 16, wherein the anode or the cathode comprises a catalyst or an ionomer.

18. The fuel cell of claim 17, wherein the catalyst comprises a precious metal catalyst, a non-precious metal catalyst, or an alloy catalyst thereof.

19. The fuel cell of claim 17, wherein the ionomer comprises a phosphoric acid-doped polybenzimidazole-based polymer.

20. A vehicle comprising the fuel cell of claim 16.
